(19) United States
(12) Patent Application Publication
(10) Pub. No.: US 2018/0320806 A1
(43) Pub. Date: Nov. 8, 2018

(54) SWIVEL PIPE COUPLING WITH RESTRAINT MEMBERS

(71) Applicant: Eliezer Krausz Industrial Development Ltd., Tel Aviv (IL)

(72) Inventor: Avi Chiproot, Kfar-Saba (IL)

(73) Assignee: Eliezer Krausz Industrial Development Ltd., Tel Aviv (IL)

(21) Appl. No.: 15/586,430

(22) Filed: May 4, 2017

(51) Int. Cl. F16L 27/08

(52) U.S. Cl. CPC F16L 27/0853

(57) ABSTRACT

A swivel pipe coupling includes two semi-spherical couplings that include mating surfaces slanted at each other. The mating surfaces include walls that extend from outside surfaces of the semi-spherical couplings. At least one of the semi-spherical couplings includes a pipe connection for receiving therein a pipe. The pipe connection includes an annular seal plus a grip ring that has wedge-shaped grip elements that are radially spaced from one another about a ring member. One or more tightening elements pass through clamp members of each pipe connection. The mating surfaces are provided with an elastomeric seal, one or more clamps and one or more tightening elements that pass through the clamps. Restraint members are located along the mating surfaces of the semi-spherical couplings, which resist forces which would tend to separate the semi-spherical couplings from each other.

### FIELD OF THE INVENTION

The present invention relates generally to pipe couplings, and particularly to a swivel pipe coupling with restraint members to help the coupling withstand forces to which it is subject.

### BACKGROUND OF THE INVENTION

Pipe lines are often connected in-line, that is, two pipe lines are connected along one continuous longitudinal axis. Sometimes the pipes are connected with elbow couplings so the two pipes are perpendicular to each other. Sometimes it is desired to allow the pipes to be connected at different angles with respect to each other to accommodate different situations in the field. For example, U.S. Pat. No. 3,762,746, issued Oct. 2, 1973, to Amada, describes a pipe connecting system which connects two pipe lines at any desired angle by connecting two semi-spherical couplings respectively with surfaces slanted at 45° to each other. This type of coupling is referred to as a swivel coupling, swivel pipe coupling or multi-angle coupling, the terms being used interchangeably.

Another example of a swivel coupling is described in applicant's PCT application WO 2008/152643 (which does not have a grip ring).

Other types of pipe couplings include a grip ring. For example, U.S. Pat. No. 7,571,940 to Krausz describes a pipe coupling that combines an elastomeric seal member with a grip ring. The grip ring is formed of wedge-shaped grip elements that are radially spaced from one another about a ring member, such as springs that connect adjacent grip rings with one another. The grip elements are formed with teeth that face inwards towards the center of the ring. A single fastener (e.g., bolt and nut or other tightenable screw) is provided, which when tightened in a direction transverse to the axial length of the pipe, presses both the elastomeric seal member and the grip ring against the surface of the pipe.

It would be desirable to provide a swivel pipe coupling with pipe connections that have grip rings. However, it has been found by the inventor that due to hydraulic forces caused by liquid flowing in the pipes, as well as other factors, the swivel pipe coupling is subject to forces that tend to make the coupling shift along the slanted mating surfaces of the semi-spherical couplings. Accordingly, a solution is needed to enable the swivel pipe coupling to withstand the hydraulic forces which the grip ring does not help withstand.

### SUMMARY OF THE INVENTION

The present invention seeks to provide an improved swivel pipe coupling with restraint members, as is described more in detail hereinbelow. The restraint members enable the swivel pipe coupling to withstand the hydraulic or any other forces which the grip ring does not help withstand.

There is thus provided in accordance with an embodiment of the present invention a swivel pipe coupling that includes two semi-spherical couplings that include mating surfaces slanted at each other, the mating surfaces including walls that extend from outside surfaces of the semi-spherical couplings, wherein at least one of the semi-spherical couplings includes a pipe connection for receiving therein a pipe, the pipe connection including an annular seal plus a grip ring, the grip ring including wedge-shaped grip elements that are radially spaced from one another about a ring member, the grip elements being formed with teeth that face inwards towards a center of the grip ring, and wherein one or more tightening elements pass through clamp members of each the pipe connection, wherein the mating surfaces are provided with an elastomeric seal, one or more clamps and one or more tightening elements that pass through the clamps, and wherein restraint members are located along the mating surfaces of the semi-spherical couplings, the restraint members being configured to resist forces which would tend to separate the semi-spherical couplings from each other.

In accordance with an embodiment of the present invention the restraint members are U-shaped with legs that extend along external side surfaces of the walls of the mating surfaces.

In accordance with an embodiment of the present invention the restraint members are spaced from one another along a length of the mating surfaces.

### BRIEF DESCRIPTION OF THE DRAWINGS

The present invention will be understood and appreciated more fully from the following detailed description, taken in conjunction with the drawing in which:

FIG. 1 is a simplified side-view illustration of a swivel pipe coupling, constructed and operative in accordance with an embodiment of the present invention;

FIG. 2 is a simplified, partially sectional view of the pipe coupling, the section showing grip rings installed in pipe connections of the coupling;

FIG. 3 is a simplified end-view of the pipe coupling;

FIG. 4 is a simplified upper perspective view of the swivel pipe coupling in the in-line configuration of FIG. 1; and

FIG. 5 is a simplified upper perspective view of the swivel pipe coupling after the two semi-spherical couplings have been turned so they are positioned at 90° with respect to each other.

### DETAILED DESCRIPTION OF EMBODIMENTS

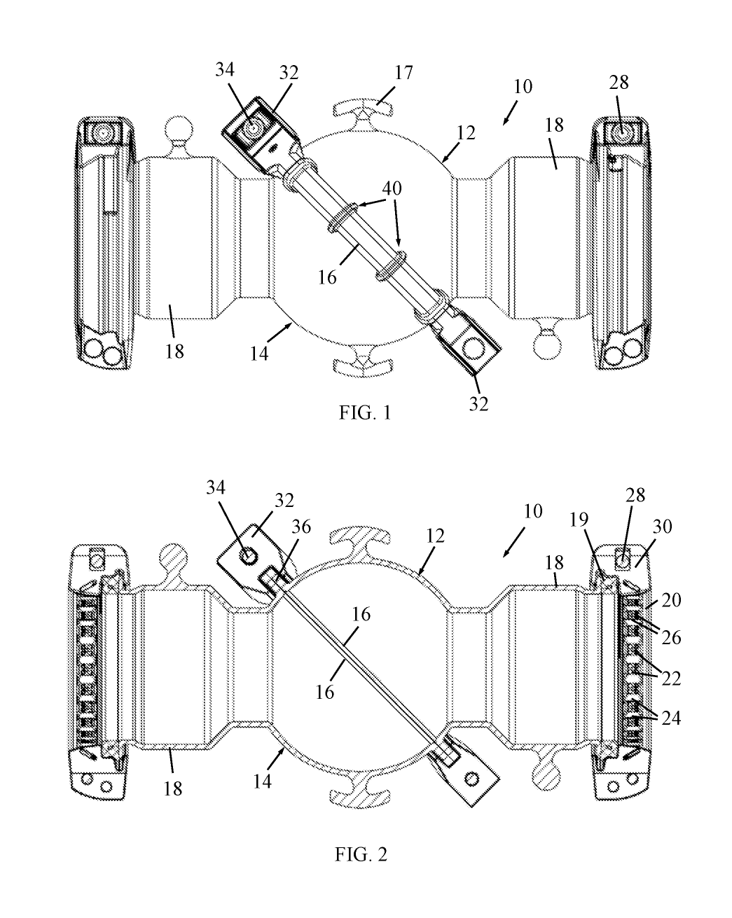

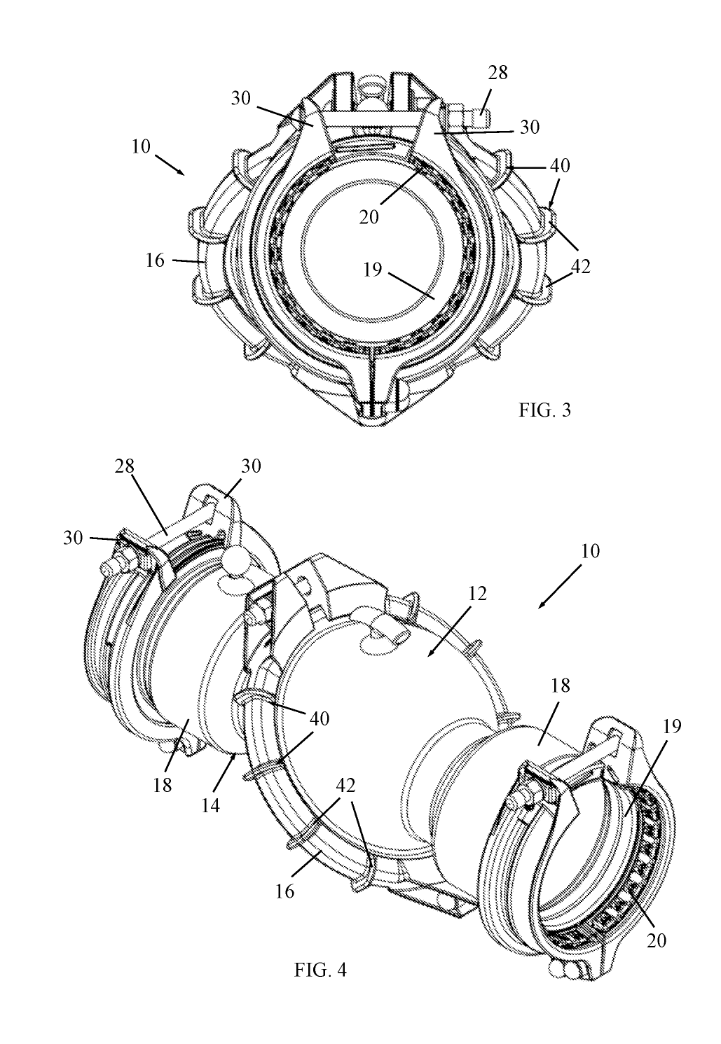

Reference is now made to FIGS. 1-4, which illustrate a swivel pipe coupling 10, constructed and operative in accordance with a non-limiting embodiment of the present invention.

Swivel pipe coupling 10 includes two semi-spherical couplings 12 and 14 with mating surfaces 16 slanted at each other, such as at an angle of 45° to each other (other angles are also possible). Each semi-spherical coupling 12 or 14 may include a carrying handle 17.

The mating surfaces 16 may include walls that extend (e.g., generally perpendicularly) from the outside surfaces of semi-spherical couplings 12 and 14.

At least one of the semi-spherical couplings 12 and 14 may include a pipe connection 18 for receiving therein a pipe (not shown). The pipe connection 18 is provided with an annular seal 19 plus a grip ring 20 for sealing a pipe inserted into the pipe connection 18. The annular seal 19, which may be made of a natural or artificial elastomeric material, may include one or more layers nested in each other. In this manner, one of the nested seals can be removed to accommodate sealing against pipes of different diameters. Annular seal 19 may be located axially inwards of the grip ring 20; alternatively annular seal 19 may be located axially outwards of the grip ring 20.

Grip ring 20 includes wedge-shaped grip elements 22 that are radially spaced from one another about a ring member 24, such as springs that connect adjacent grip rings with one another. The grip elements 22 are formed with teeth 26 that face inwards towards the center of the ring 20. One or more tightening elements 28 (e.g., bolts and nuts or other tightenable fasteners) pass through clamp members 30 of each pipe connection 18. The tightening elements 28, when tightened in a direction transverse to the axial length of the pipe, press both the annular seal 19 and the grip ring 20 against the surface of the pipe. Annular seal 19 is radially squeezed and sealingly clamped against the outside surface of the pipe when tightening elements 28 fasten and tighten clamp members 30 towards each other. The teeth 26 of the wedge-shaped grip elements 22 are forced into the outside surface of the pipe when tightening elements 28 fasten and tighten clamp members 30 towards each other.

The mating surfaces 16 of the semi-spherical couplings 12 and 14 may be provided with one or more clamps 32 and one or more tightening elements 34 (e.g., bolts and nuts or other tightenable screws) that pass through clamps 32. In the non-limiting illustrated embodiment, two sets of clamps 32 are provided, which are spaced 180° from each other. An elastomeric seal 36 is provided around the outer perimeter of the mating surfaces 16. When the tightening elements 34 are tightened, they press elastomeric seal 36 against the mating surfaces 16, thereby creating a sealed connection between semi-spherical couplings 12 and 14.

In accordance with an embodiment of the present invention, restraint members 40 are located along mating surfaces 16 of the semi-spherical couplings 12 and 14. The restraint members 40 are U-shaped with legs 42 that extend along the external side surfaces of the walls that make up the mating surfaces 16. The restraint members 40 are spaced from one another along the length of the mating surfaces 16. The restraint members 40 may be made of the same or different material as the mating surfaces 16, such as but not limited to, stainless steel or other steel alloys. The restraint members 40 resist forces which would tend to separate the semi-spherical couplings 12 and 14 from each other.

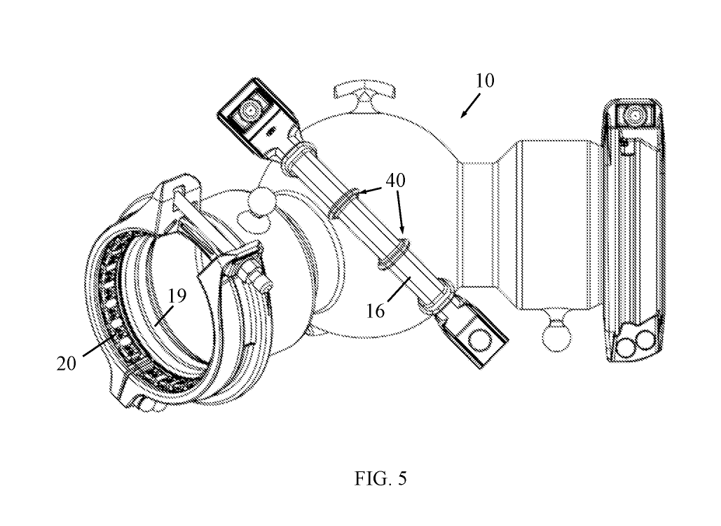

As seen in FIGS. 4 and 5, the semi-spherical couplings 12 and 14 of swivel pipe coupling 10 may be aligned with each other to be in an in-line configuration (FIG. 4) or at an angled configuration, such as in FIG. 5, in which the two semi-spherical couplings 12 and 14 have been turned so they are positioned at 90° with respect to each other. In any of the orientations, restraint members 40 resist forces which would tend to separate the semi-spherical couplings 12 and 14 from each other.

What is claimed is:

1. A swivel pipe coupling comprising:
two semi-spherical couplings that comprise mating surfaces slanted at each other, said mating surfaces comprising walls that extend from outside surfaces of said semi-spherical couplings;
wherein at least one of said semi-spherical couplings comprises a pipe connection for receiving therein a pipe, said pipe connection comprising an annular seal plus a grip ring, said grip ring comprising wedge-shaped grip elements that are radially spaced from one another about a ring member, said grip elements being formed with teeth that face inwards towards a center of said grip ring, and wherein one or more tightening elements pass through clamp members of each said pipe connection;
wherein said mating surfaces are provided with an elastomeric seal, one or more clamps and one or more tightening elements that pass through said clamps;
and wherein restraint members are located along said mating surfaces of said semi-spherical couplings, said restraint members being configured to resist forces which would tend to separate said semi-spherical couplings from each other.

2. The swivel pipe coupling according to claim 1, wherein said restraint members are U-shaped with legs that extend along external side surfaces of the walls of said mating surfaces.

3. The swivel pipe coupling according to claim 1, wherein said restraint members are spaced from one another along a length of said mating surfaces.

4. The swivel pipe coupling according to claim 1, wherein said restraint members are made of same material as said mating surfaces.

5. The swivel pipe coupling according to claim 1, wherein said restraint members and said mating surfaces are made of different materials.

6. The swivel pipe coupling according to claim 1, wherein said annular seal comprises one or more layers nested in each other.
